(19) United States
(12) Patent Application Publication
(10) Pub. No.: US 2025/0376033 A1
(43) Pub. Date: Dec. 11, 2025

(54) REDUCED POWERTRAIN LOAD ON BATTERY CONTACTOR

(71) Applicant: Caterpillar Inc., Peoria, IL (US)

(72) Inventors: Rodney Menold, Hanna City, IL (US); Jason Lee Miller, Princeville, IL (US); Bradley Scott Bailey, Edwards, IL (US)

(73) Assignee: Caterpillar Inc., Peoria, IL (US)

(21) Appl. No.: 18/738,983

(22) Filed: Jun. 10, 2024

(51) Int. Cl. B60L 3/04; B60L 3/12; B60L 58/16; H02J 7/00

(52) U.S. Cl. CPC B60L 3/04; B60L 3/12; B60L 58/16; H02J 7/0031; H02J 7/0048; B60L 2270/20

(57) ABSTRACT

An electric work machine that has a powertrain controller and a battery system is disclosed. The battery system has at least one battery string that, when they are all connected, form a circuit of the battery system. One or multiple battery modules and a contactor are connected in series to form each battery string. When a battery string is to be taken offline, a battery control system sends a warning signal to a powertrain controller to reduce a current being drawn from the battery system prior to the connector opening up to disconnect the battery string that is being taken offline from the circuit.

### TECHNICAL FIELD

The present disclosure generally relates to the field of electric work machines to be used in the mining and construction industries, and more particularly, to battery systems of electric work machines.

### BACKGROUND

Many battery systems for electric work machines, such as those used in the construction, agriculture, earth-moving, oil extraction, and mining industries, include electrically controlled switches such as contactors or relays that open and close to disconnect or connect, respectively, power modules to a circuit of the battery system. These contactors may experience failure in which the contactor welds closed, or increased wear, caused by the high current flowing when the contactor is being opened or closed. This effectively causes the contractor to fail with the contactor permanently closed, or frequent need for replacement of the contactor due to the increased wear.

Conventionally, the current of power modules is fully or partially rerouted around the contactor prior to it being open or closed to reduce wear on the contactor. For example, in U.S. Pat. No. 11,483,134, a power control system detects fault currents such as current spikes and protects the battery pack(s) and other components by creating a current divider through the contactor and fuse of the ASPD (active sacrificial protection device). In other words, the contactor of the ASPD is closed, or opened, to provide an alternate pathway for current to travel to reduce the current through one of the main contactors to allow the main contactor to be opened. Once the main contactor is opened, all of the current flows through the fuse of the ASPD.

While effective, there remains a need for improved systems and methods for electric work machines used in high wear applications, such as construction and mining, that minimize wear and replacement of wear components, such as fuzes and contactors, in order to minimize machine maintenance and downtime.

### SUMMARY

In accordance with one aspect of the present disclosure, an electric work machine with a powertrain controller and a battery system is disclosed. The battery system consists of a battery string that has one or more battery modules arranged in series with a contactor. When the contactor is in a closed position, the battery modules provide power via a circuit to various components of the electric work machine. Additionally, a battery control system manages the contactor, moving it to an open position to disconnect the battery string from the circuit and to a closed position to connect it. The powertrain controller responds to a warning signal from the battery control system by reducing current drawn from the battery system when the contactor is about to be moved to the open position.

In accordance with another aspect of the present disclosure, a powertrain controller designed for an electric work machine is disclosed. Its purpose is to direct a first current from a battery system to power an electric motor, propelling the electric work machine. The battery system consists of a battery string that has one or more battery modules and a battery contactor arranged in series. When the battery contactor is opened, it connects the battery modules of the battery string to the circuit, and when it's closed, it disconnects them from the battery system. Additionally, a battery control system sends a warning signal to the powertrain controller before the powertrain controller directs a second current to the electric motor from the circuit. This second current is reduced compared to the first current when flowing through the battery contactor prior to the contactor being opened by the battery control system to take the battery string offline by disconnecting it.

In accordance with another aspect of the present disclosure, a method for taking a battery string offline from a circuit of a battery system of an electric work vehicle is disclosed. The method involves supplying a first current from at least one battery module in the battery string to a battery contactor connected in series with the at least one battery module to form the battery string. When the battery contactor is about to be moved from a closed position (connecting the battery modules to the circuit) to an open position (disconnecting them from the circuit), a powertrain controller of the electric work machine receives a warning signal from the battery control system. Prior to disconnecting the battery string from the circuit, the powertrain controller reduces the current drawn from the battery system, including the current drawn from the battery module initially supplied to power various components of the electric work machine. Finally, the battery control system opens the battery contactor, disconnecting the flow of current from the battery module to the circuit.

These and other aspects and features of the present disclosure will be more readily understood when read in conjunction with the accompanying drawings.

### BRIEF DESCRIPTION OF THE DRAWINGS

FIG. 1 is a side view of an electric work machine, in accordance with aspects of the present disclosure.

FIG. 2 is a block diagram illustrating a control system included in the electric work machine, in accordance with the present disclosure.

FIG. 3 is a block diagram illustrating a battery system included in the electric work machine, in accordance with the present disclosure.

FIG. 4 is a block diagram illustrating an exemplary method of taking a battery string of the battery system offline, in accordance with aspects of the present disclosure.

### DETAILED DESCRIPTION

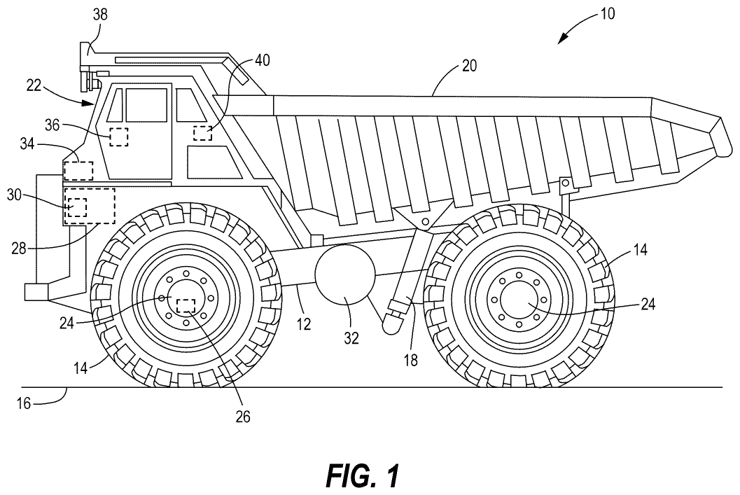

Referring to FIG. 1, a schematic illustration of an electric work machine 10 in which load management in accordance with the present disclosure may be implemented. The electric work machine 10, although depicted as a large mining truck, may be any suitable machine, such as any type of loader, dozer, dump truck, skid loader, excavator, backhoe, combine, crane, drilling equipment, trencher, tractor, any suitable stationary machine, any variety of generator, locomotive, marine engines, combinations thereof, or the like, in which an electric motor driven hydraulic system, or directly electrically driven system, may be implemented. As shown in FIG. 1, the electric work machine 10 includes a frame 12 and wheels 14. The wheels 14 are mechanically coupled to a drive train (not shown) to propel the electric work machine 10 over a work surface 16. When the wheels 14 of the electric work machine 10 are caused to rotate, the electric work machine 10 traverses the ground 16. Although illustrated in FIG. 1 as having a hub with a rubber tire, in other examples, the wheels 14 may instead be in the form of drums, chain drives, combinations thereof, or the like. The frame 12 of the work machine 10 is constructed from any suitable materials, such as iron, steel, aluminum, other metals, ceramics, plastics, the combination thereof, or the like. The frame 12 may be of a unibody construction in some implementations, and in other implementations may be constructed by joining two or more separate body pieces by an articulated joint.

The electric work machine 10 may include a hydraulic system 18 that provides power to move an implement assembly 20, such as a dump box as depicted in FIG. 1, or other moveable elements of the electric work machine 10 that are configured to move, lift, carry, and/or dump materials, or to perform other functions of the electric work machine 10. The implement assembly 20 may be used, for example, to pick up and carry dirt or mined ore from one location on the work surface 16 to another location of the work surface 16. The implement assembly 20 may be raised and lowered by the hydraulic system 18 to empty a payload that has been deposited by another electric work machine, or to provide access to components of the electric work machine 10 for inspection and maintenance. For purposes of the present disclosure, the hydraulic system 18 may be powered by an electric motor powering a hydraulic pump(s) to provide pressurized fluid to move the implement assembly 20 as discussed further below.

With continued reference to FIG. 1, the electric work machine 10 may also include an operator station 22. The operator station 22 is configured to seat an operator (not shown) therein. The operator seated in the operator station 22 interacts with various control interfaces and/or actuators within the operator station 22 to control movement of various components of the electric work machine 10 and/or the overall movement of the electric work machine 10 itself. Thus, control interfaces and/or actuators within the operator station 22 allow the control of the propulsion of the electric work machine 10 by controlling operation of one or more propulsion electric motors 24 to drive the wheels 14, and the control of other motors of the electric work machine 10, such as an electric motor (not shown) for the hydraulic system 18 as discussed further below. The motors will be referred to collectively as electric motors 24. A motor controller 26 may be controlled according to operator inputs received at the operator station 22 and control the operation of the electric motors 24 in response.

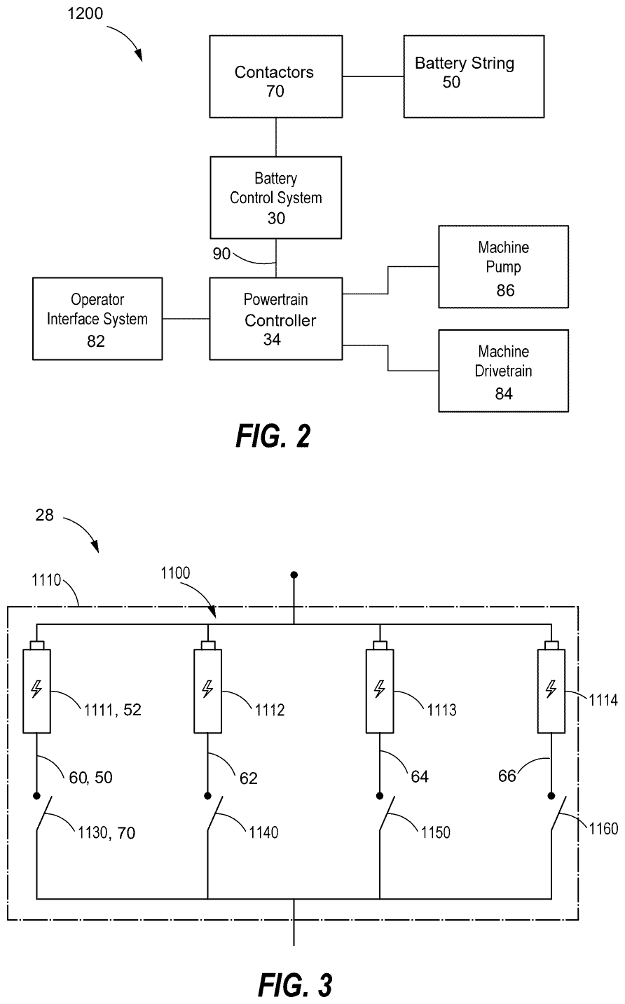

Turning to FIG. 2, the electric work machine 10 includes a control system 1200. The control system 12 includes a powertrain controller 34 and a battery control system 30. In practice, the operator station contains the operator interface system 82, which sends signals to the powertrain controller 34 to command the powertrain controller 34 to move the implement assembly 20, or propel the electric work machine 10 by commanding the electric motors 24 that power the wheels of the electric work machine 10. This may include the powertrain controller 34 commanding the machine drivetrain 84 to activate it's electric motors 24 to propel the electric work machine 10 or any machine pumps 86, or electric motors, to activate and move the implement assembly 20. The powertrain controller 34 is connected to the battery control system 30, which controls the flow of electricity from the battery strings 50, as discussed below. Further, the powertrain controller 34 determines the draw of current, or current load, from the battery system 28, as how fast to move the machine drivetrain 84, how quickly to have machine pumps 86 move the implement assembly 20, or the amount of load using electrical devices from the electrical machine being commanded to operate from the powertrain controller 34 all has an impact on the amount of current load being drawn from the battery system 28.

The electric motors 24 may be powered by the battery system 28, that includes electric power delivery devices such as a battery pack or battery strings 50, discussed below, with the battery system being controlled by the battery control system 30. The electric motors 24 may be of any suitable type, such as induction motors, permanent magnet motors, switched reluctance (SR) motors, combinations thereof, or the like. The electric motors 24 are of any suitable voltage, current, and/or power rating. The powertrain controller 34 may include one or more control electronics to control the operation of the electric motors 24, or one or more components of the electric work machine 10. In some cases, each electric motor 24 may be controlled by its own motor controller (not shown). In other cases, all the electric motors 24 of the electric work machine 10 may be controlled by the powertrain controller 34. The electric motors 24 may be mechanically coupled to a variety of drive train components, such as the machine drivetrain 84 that includes a drive shaft and/or axles or directly to the wheels 14 to rotate the wheels 14 and propel the electric work machine 10, or directly or indirectly to pumps and/or other auxiliary components, such as the machine pumps 86, to operate other systems of the electric work machine 10 such as the hydraulic systems 18. The electric work machine 10 may further optionally include a supplementary power source, such as an internal combustion engine (not shown), and have a fuel tank 32 to store an appropriate fuel, such as diesel, gasoline, or other hydrocarbon fuels. The supplementary power source may serve as a backup power source in the event of a failure of the battery system 28, may provide power to charge the battery system 28 when an external charging source is unavailable, or may function as a primary power source for some systems of the electric work machine 10.

The battery system 28 may be of any suitable type and capacity. For example, the battery may be a lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. The battery system 28 may be organized as a collection of electrochemical cells arranged to provide the voltage, current, and/or power requirements of the electric motors 24. In some implementations, the energy capacity of the battery system 28 may be a threshold amount more than the energy required for the electric work machine 10 to traverse a specified distance over the work surface 16 or to perform work for a specified period of time. For example, if a particular electric work machine 10 is prescribed to have an operating range of 50 kilometers (km), the battery system 28 of the electric work machine 10 may be designed to have sufficient capacity to propel the electric work machine 10 for 75 km. Alternatively, if the electric work machine 10 is prescribed to operate for 10 hours before being taken out of service, the battery system 28 may be designed to have sufficient capacity to operate the electric work machine 10 for 13 hours. A ratio of the energy capacity of the battery system 28 to the energy need to perform required operations may be any suitable value to provide a desired margin of excess capacity to ensure completion of the operations under normal operating conditions.

The battery system 28 includes one or more battery strings 50 which include one or more battery modules 52 connected in series by wires or electrical cables. Each battery string also has a contactor 70, such as the first contactor 1130, discussed in more detail below. The battery strings 50, as best shown in FIG. 3, are connected in parallel with other battery strings to form a circuit, such as circuit 1100. Thus, FIG. 3 depicts a first battery string 60, second battery string 62, third battery string 64, and fourth battery string 66 connected in parallel to form the circuit 1100. The battery strings may be stored inside of a shell, container, or battery pack 1110 for connecting to and powering the electric work machine 10. In another exemplary embodiment, each battery string plugs into an electrical busbar (not shown), with each battery string able to be connected to or disconnected to the electrical busbar with their respective contactor.

The battery module 52, such as the first battery module 1111, second battery module 1112, third battery module 1113, and fourth battery module 1114, as depicted in FIG. 3, may be a singular battery, or battery cell, or be a group of batteries or cells, which may or may not be inside of a battery container, box, or battery pack. Although the FIG. 3 exemplary embodiment depicts a singular battery module 52 on each battery string 50, each battery string may contain one or more battery modules that are linked together in series.

Each battery string 50 has at least one battery module 52 linked, being connected by wire or cable, in series with a contactor 70, such as the first contactor 1130, second contactor 1140, third contactor 1150, and fourth contactor 1160 depicted in FIG. 3. The contactors 70 may include a device (e.g., a switch) that are configured to be in a closed state to connect their battery string 50 to the circuit 1100, or in an open state to disconnect their battery string 50 from the battery circuit 1100. For example, the first battery string 60 includes the first battery module 1111 and the first contactor 1130. When the first contactor 1130 is in the closed state (or position), or moved to the closed state, the first battery string 60 is connected to the circuit 1100 and power from the first battery module 1111 is flowing as part of the circuit and is used in the powering of the electrical work machine 10. When the first contactor 1130 is in the open state (or position), or moved to the open state, the first battery string 60 is disconnected from the rest of the circuit 1100 and power from the first module 1111 is not flowing as part of the circuit and is not sued in powering the electrical work machine 10. Although one or more of the battery strings 50 may be in the open state, the remainder of the battery strings 50 that are in the closed state may still be used to power the electrical systems and movements of the electrical work machine 10.

The electric work machine 10 may include the powertrain controller 34 that controls various operational aspects of the electric work machine 10. The powertrain controller 34 may configured to receive electric power source status (e.g., state-of-charge (SOC) or other charge related metrics) from the battery control system 30, operator signal(s), such as an accelerator signal or dump lift signal, based at least in part on the operator's interactions with one or more control interfaces and/or actuators 36 in the operator station 22 of the electric work machine 10. In other implementations, the powertrain controller 34 may receive control signals from a remote control system by wireless signals received via an antenna 38. The powertrain controller 34 may use the operator signal(s), regardless of whether they are received from an operator in the operator station 22 or via the antenna 38, to generate command signals to control various components of the electric work machine 10. For example, the powertrain controller 34 may control the electric motors 24 via the motor controller 26, the hydraulic system 18, and/or steering of the electric work machine 10 via a steering controller 40. It should be understood that the powertrain controller 34 may control any variety of other subsystems of the electric work machine 10 that are not explicitly discussed here to provide the electric work machine 10 with the operational capability discussed herein.

The battery control system 30 is used to move the contactors 70 independently in each battery string 50 from the open state to closed state, or from the closed state to the open state. Thus, the battery control system 80 is used to connect or disconnect each battery string 50 from the circuit 1100. For example, if a battery module, such as the first battery module 1111 is depleted of charge, has detected a fault current, or any other reason that the battery string needs to be taken offline due to the battery modules 52 within that battery string 50, the battery control system 80 can take that battery string 50 offline by opening its contactor 70 and removing its current contribution from the circuit 1100. Additionally, the battery control system 30 is in communication with the powertrain controller 34. The powertrain controller 34, due to load requirements to perform operations commanded by the operator interface system 82, can increase or decreases requested current flowing from the power system 28 by commanding the power control system 30 to open or close the contactors 70 to provide the requested amount of load current.

When the battery control system 80 determines that a specific battery string 50 needs to be taken offline due to any of the reasons given above, it will move the battery contactor 70 of that battery string 50 to the open state. Since the battery control system 30 is in communication with the powertrain controller 34, the battery control system 30 sends a warning signal 90 to the powertrain controller 34 that the battery control system 30 is about to take one of the battery strings 50 offline by moving its contactor 70 to the open state. The powertrain controller 34, upon receiving this warning signal 90, will reduce its current load being drawn from the battery system 28 in order to reduce the current load being drawn from the circuit 1100 having the battery string 50 being taken offline. This reduces the current load on the contactor 70 when it is moved from the closed state to the open state. The powertrain controller 34 can reduce the current load by slowing the machine drive train 84, reducing the amount of machine pumps 86 being used, or reducing the number of electrical devices (such as electric motor 24) of the electric work machine 10 that are being used.

Those skilled in the art will understand that the functionality for monitoring and operating the electric work machine 10 being distributed across multiple controllers such as the controllers 30, 34, for example, is exemplary, and alterative control structure architectures are possible. The controllers 30, 34 may be physically separate devices. Alternatively, some or all of the control functions of the controllers 30, 34 described herein may be implemented fewer control devices if necessary based on the requirements and constraints for a particular electric work machine 10. Where control strategies are discussed in this description and the claims, unless otherwise specified, implementation of the control strategies in a single control device or by distribution across multiple control devices is contemplated by the inventors as having use in implementing hydraulic load management in accordance with the present disclosure.

### INDUSTRIAL APPLICABILITY

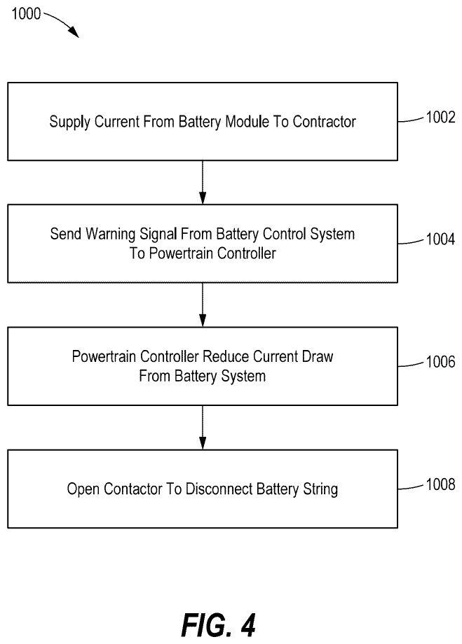

The electric work machine 10 having a battery system 28 of the present disclosure, as depicted in FIGS. 1-3 above, relate to increasing operational efficiency and reducing wear on electrical components in the construction and heavy machinery industries. During a work operation involving the electrical work machine 10, the contactors 70 of its battery system 28 are sustained to increased wear when they are moved to an open state from a closed state under increased current loads demanded from its powertrain controller 34. As depicted in FIG. 4, with continued reference to FIGS. 1-3, a method 1000 of taking a battery string of the battery system offline is shown.

In the first block 1002, the powertrain controller 34 demands a current load from the battery system 34 in order to facilitate the operation of the machine drivetrain 84 and any machine pumps 86. To supply this current load, the battery system 28 includes a battery string 50 that has at least one battery module 52 and contactor 70 connected in series, with the current flowing from the battery module 52 through the contactor 70 to a circuit 1100 to supply the current to the electrical devices under command of the powertrain controller 34. Multiple battery strings 50 may be connected to form the circuit 1100.

Occasionally, one of the battery strings 50 may need to be taken offline due to a number of issues, including the battery module 52 has become depleted or a fault current in the battery string 50 has been detected. To take the battery string 50 offline, the contactor 70 is commanded by the battery control system 30 to move from the closed state to the open state. However, when the contactor 70 is moved to the open state under high current loads, it is more susceptible to wear, or can become welded shut under extreme current loads.

To ensure that the contactor 70 is not opened under these high current loads, at block 1004, the powertrain controller 34 receives a warning signal 90 from the battery control system 30 that the battery control system 30 is about to move the contactor 70 to the open state. Upon receiving this warning signal 90, at block 1106, the powertrain controller 34 will reduce current being drawn from the battery system 28 in order to reduce the current on the contactor 70 to a level that is lower than the level of current on the contactor before the warning signal 90 was sent. The powertrain controller 34 may reduce the demanded current load by reducing the speed of the drivetrain, turn off some of the electric motors or electric pumps being used by the electric work machine, or a combination of reducing the amount of electrical devices and the speed of these electrical devices.

At block 1108, the battery control system 28 will open the contactor 70 from the closed state to the open state, thus disconnecting the flow of current drawn to the circuit from any power modules that are on the disconnected battery string. Thus, the contactor 70 is moved to the open state under reduced current than what the contactor 70 was under prior to the warning signal 90 being sent. This reduces the overall amount of wear on the contactor 70, reducing the amount of potential downtime of the electric work machine 10 required to replace any worn contactors, and improves the efficiency of the electric work machine 10.

While the preceding text sets forth a detailed description of numerous different embodiments, it should be understood that the legal scope of protection is defined by the words of the claims set forth at the end of this patent. The detailed description is to be construed as exemplary only and does not describe every embodiment since describing every embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. An electric work machine having a powertrain controller and a battery system, the battery system comprising:
a battery string comprising one or more battery modules arranged in series with a contactor, the one or more battery modules configured to provide power via a circuit to one or more components of the electric work machine when the contactor is in a closed position; and
a battery control system configured to move the contactor to an open position to disconnect the battery string from the circuit and move the contactor to the closed position to connect the battery string to the circuit, the powertrain controller configured to reduce current drawn from the battery system upon receiving, from the battery control system, a warning signal that the contactor is about to be moved to the open position.

2. The electric work machine of claim 1, in which battery system further comprises additional battery strings with all battery strings of the battery system in a parallel arrangement, in which the additional battery strings are configured to supply the reduced current load to power the one or more components of the electric work machine prior to the contactor being moved to the open position.

3. The electric work machine of claim 3, in which after the contactor is moved to the open position, each of the additional battery strings configured to provide the current to the circuit to power the one or more components at the rate provided prior to being reduced in response to the warning signal.

4. The electric work machine of claim 1, in which a load sensor of the battery system is configured to measure the current and ensure the current is reduced prior to the opening of the contactor.

5. The electric work machine of claim 1, in which the current is supplied from the battery system to the one or more components of the electric work machine including one or more of a machine pump, a drivetrain, or an electric motor.

6. The electric work machine of claim 1, in the battery module is comprised of one or more batteries inside of a battery container.

7. The electric work machine of claim 6, in which the battery control system is configured to monitor health information of all batteries or battery modules of the battery system, the health information including one or more of a state of charge (soc), a temperature, a voltage, a fault current, or the current.

8. The electric work machine of claim 7, in which the battery control system is configured to, while monitoring the health information, determine that the battery string needs to be taken offline based on the health information.

9. The electric work machine of claim 8, in which the battery control system is configured to send the warning signal if the battery control system determines that the battery string needs to be taken offline.

10. The electric work machine of claim 1, in which the battery string uses connectors including cables or wiring to connect the one or more battery modules to the contactor.

11. A powertrain controller for an electric work machine configured to direct a first current from a battery system of the electric work machine for use in powering a load on a battery system comprising:
a battery string that includes one or more battery modules and a battery contactor that are arranged in series with each other, the battery contactor connecting the one or more battery modules to a circuit of the battery system when the battery contactor is open and disconnecting the one or more battery modules from the circuit when the battery contactor is closed; and
a battery control system configured to send a warning signal to the powertrain controller prior to the powertrain controller directing a second current from the battery system to the electric motor, in which the second current is configured to be reduced compared to the first current when flowing through the battery contactor before the battery contactor is moved by the battery control system to be open from closed to disconnect the battery string.

12. The powertrain controller of claim 11, in which the battery system further includes a load sensor to measure the current in the battery string.

13. The powertrain controller of claim 12, in which the battery control system receives a current measurement from the load sensor prior to sending the warning signal to the powertrain.

14. The powertrain controller of claim 13, in which after sending the warning signal, the load sensor is configured to continue to measure the current until the current falls below a predetermined current threshold before the battery control system opens the contactor.

15. The powertrain controller of claim 14, in which the current is reduced by the powertrain controller reducing the load on the battery system.

16. The powertrain controller of claim 15, in which the powertrain is configured to reduce the load by slowing the movement speed of the electric work machine.

17. The powertrain controller of claim 15, in which the powertrain controller is configured to reduce the load of the electric work by limiting the amount of, or rate of current being sent to, one or more components of the electric work machine that powertrain controller is directing the current.

18. The powertrain controller of claim 17, in which the one or more components includes the electric motors, electric systems, and electric pumps of the electric work machine.

19. The powertrain controller of claim 15, in which the electric work machine further includes an implement assembly powered directly by an electric motor or a hydraulic system powered by the electric motor, and the powertrain controller reduces the load by limiting the movement speed of the implement assembly.

20. A method of taking a battery string of a battery system offline for an electric work vehicle, the method comprising:
supplying a first current from at least one battery module of the battery string of the battery system to a battery contactor in series connection with the at least one battery module;
receiving at a powertrain control of the electric work machine from a battery control system of the battery system a warning signal that the battery contactor is about to be moved to an open position from a closed position to disconnect the at least one power modules of the battery string from the circuit;
prior to the disconnecting the battery string from the circuit, the powertrain controller reducing current drawn from the battery system, the current drawn including current drawn from the at least one battery module supplied to the circuit before being supplied to one or more components of the electric work machine;
the battery control system opening the battery contactor from a closed position to the open position disconnecting the flow of current drawn to the circuit from the at least one power module.
